(19) United States
(12) Patent Application Publication
(10) Pub. No.: US 2024/0186612 A1
(43) Pub. Date: Jun. 6, 2024

(54) BATTERY PACK

(71) Applicant: MURATA MANUFACTURING CO., LTD., Kyoto (JP)

(72) Inventor: Yuta NIKAIDO, Kyoto (JP)

(21) Appl. No.: 18/441,636

(22) Filed: Feb. 14, 2024

Related U.S. Application Data
(63) Continuation of application No. PCT/JP2022/025503, filed on Jun. 27, 2022.

(30) Foreign Application Priority Data
Sep. 24, 2021 (JP) 2021-155243

(51) Int. Cl. H01M 10/6555; H01M 10/613; H01M 10/643; H01M 10/653; H01M 50/213; H01M 50/291; H01M 50/502

(52) U.S. Cl. CPC H01M 10/6555; H01M 10/613; H01M 10/643; H01M 10/653; H01M 50/213; H01M 50/291; H01M 50/502; H01M 2200/10

(57) ABSTRACT

A battery pack includes a plurality of batteries, an isolating member that is arranged among the plurality of batteries and isolates the plurality of batteries from each other, and a heat absorbing agent that is housed inside the isolating member and cools the plurality of batteries. The isolating member includes a housing portion that is arranged among the plurality of batteries and houses a heat absorbing agent inside, and a heat conduction part that is arranged between the housing portion and each of the plurality of batteries and has a thermal conductivity higher than a thermal conductivity of the housing portion.

### CROSS REFERENCE TO RELATED APPLICATIONS

The present application is a continuation of PCT patent application No. PCT/JP2022/025503, filed on Jun. 27, 2022, which claims priority to Japanese patent application no. 2021-155243, filed on Sep. 24, 2021, the entire contents of which are incorporated herein by reference.

### BACKGROUND

The present technology relates to a battery pack.

Since electronic equipment has been widely spread, a battery has been developed as a power source applied to the electronic equipment. In this case, in order to handle a plurality of batteries easily and safely, a battery pack including the plurality of batteries has been proposed.

Various studies have been made on the technology related to the configuration of the battery pack. Specifically, a heat absorbing member is in contact with a side surface of the battery unit, and in the heat absorbing member, a heat absorbing agent (liquid or gel-like fluid) is contained inside the exterior film. An endothermic substance housing structure that breaks down at a predetermined temperature is housed inside the container of the secondary battery, and the endothermic substance housing structure houses the endothermic substance inside.

### SUMMARY

The present technology relates to a battery pack.

Various studies have been made on the configuration of the battery pack, but the safety of the battery pack is still insufficient, and there is room for improvement.

Therefore, a battery pack capable of obtaining excellent safety is desired.

A battery pack according to an embodiment of the present technology includes a plurality of batteries, an isolating member that is arranged among the plurality of batteries and isolates the plurality of batteries from each other, and a heat absorbing agent that is housed inside the isolating member and cools the plurality of batteries. The isolating member includes a housing portion that is arranged among the plurality of batteries and houses a heat absorbing agent inside, and a heat conduction part that is arranged between the housing portion and each of the plurality of batteries and has a thermal conductivity higher than a thermal conductivity of the housing portion.

According to the battery pack of an embodiment of the present technology, the isolating member isolates the plurality of batteries from each other, the isolating member houses the heat absorbing agent inside, the isolating member includes the housing portion and the heat conduction part, the housing portion houses the heat absorbing agent inside, and the heat conduction part arranged between the housing portion and each of the plurality of batteries has the thermal conductivity higher than the thermal conductivity of the housing portion, and thus excellent safety can be obtained.

The effect of the present technology is not necessarily limited to the effect described here, and may be any effect of a series of effects relating to the present technology.

### BRIEF DESCRIPTION OF THE FIGURES

FIG. 1 is an exploded perspective view illustrating a configuration of a battery pack according to an embodiment of the present technology.

FIG. 2 is another exploded perspective view illustrating the configuration of the battery pack illustrated in FIG. 1.

FIG. 3 is a sectional view illustrating the configuration of the battery pack illustrated in FIG. 1.

FIG. 4 is an exploded perspective view illustrating a configuration of a partition plate illustrated in FIG. 2.

FIG. 5 is a perspective view illustrating a configuration of the partition plate illustrated in FIG. 2.

FIG. 6 is a plan view illustrating a configuration of the partition plate illustrated in FIG. 2.

FIG. 7 is an enlarged sectional view illustrating a configuration of a secondary battery illustrated in FIG. 2.

FIG. 8 is a plan view illustrating a configuration of a battery pack (partition plate) according to an embodiment.

FIG. 9 is a plan view illustrating another configuration of a battery pack (partition plate) according to an embodiment.

FIG. 10 is an exploded perspective view illustrating a configuration of a battery pack according to an embodiment.

FIG. 11 is a sectional view illustrating a configuration of the battery pack illustrated in FIG. 10.

FIG. 12 is a perspective view illustrating a configuration of a battery pack (partition plate) according to an embodiment.

FIG. 13 is a plan view illustrating a configuration of a battery pack (partition plate) according to an embodiment.

### DETAILED DESCRIPTION

The present technology will be described in further detail below including referring to the accompanying drawings.

First, a battery pack according to an embodiment of the present technology is described.

The battery pack described herein is a power supply including a plurality of batteries, and is applied to various applications such as electronic devices. Details of the application of the battery pack will be described later.

The kind of the battery is not particularly limited, and may be a primary battery or a secondary battery. The kind of the secondary battery is not particularly limited, and is specifically a lithium ion secondary battery or the like in which a battery capacity is obtained using occlusion and release of lithium ions. The number of batteries is not particularly limited, and thus can be arbitrarily set.

Hereinafter, a case where the battery is a secondary battery (lithium ion secondary battery) will be described. That is, the battery pack described below is a power supply including a plurality of secondary batteries.

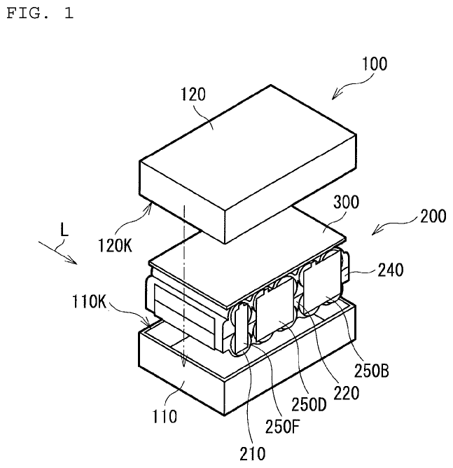

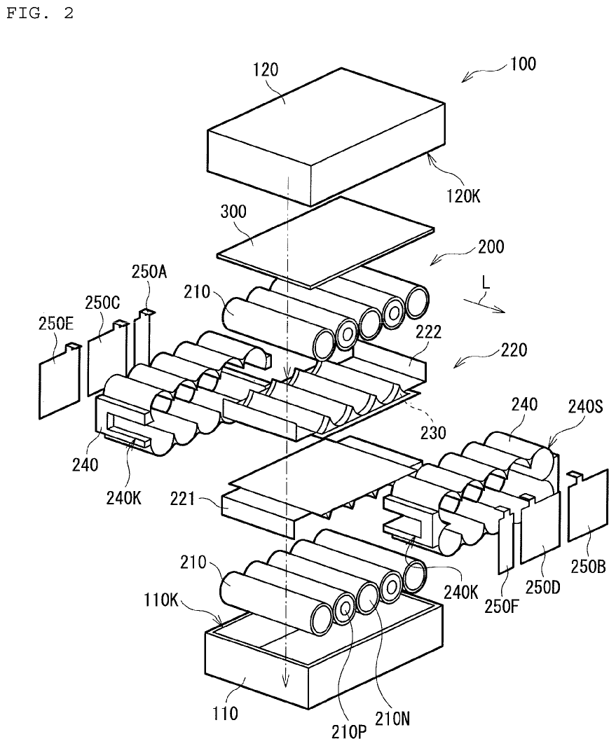

FIGS. 1 and 2 each illustrate a perspective configuration of a battery pack. FIG. 3 illustrates a sectional configuration of the battery pack illustrated in FIG. 1.

Here, FIGS. 1 and 2 each illustrate a state in which the battery pack is disassembled. More specifically, in FIG. 1, an exterior case 100 and a battery module 200 are separated from each other, and in FIG. 2, the battery module 200 is further disassembled. FIG. 3 illustrates a section of the battery pack along a plane intersecting an extending direction (length direction L) of a secondary battery 210 described later.

As illustrated in FIGS. 1 to 3, the battery pack includes the exterior case 100, the battery module 200, and a control board 300.

In the following description, the upper side in each of FIGS. 1 to 3 is referred to as an “upper side” of the battery pack, and the lower side in each of FIGS. 1 to 3 is referred to as a “lower side” of the battery pack. The right side in FIGS. 1 to 3 is referred to as a “back side” of the battery pack, and the left side in each of FIGS. 1 to 3 is referred to as a “front side” of the battery pack.

As illustrated in FIGS. 1 to 3, the exterior case 100 is a second exterior member that accommodates the battery module 200 and the like inside. That is, the exterior case 100 accommodates a plurality of secondary batteries 210, a partition plate 220, a heat absorbing agent 230, and the like inside, which will be described later. Here, the exterior case 100 includes a lower case 110 and an upper case 120 which are separated from each other.

The lower case 110 has a vessel-like structure in which the lower end is closed and the upper end is opened, and thus has an opening 110K at the upper end thereof. A material of the lower case 110 is not particularly limited, and can be arbitrarily set.

The upper case 120 has a vessel-like structure in which the upper end is closed and the lower end is opened, and thus has an opening 120K at the lower end thereof. A material of the upper case 120 is not particularly limited, and can be arbitrarily set.

Here, the lower case 110 and the upper case 120 are arranged in such a manner that openings 110K and 120K face each other, and are fixed to each other by fixing screws (not illustrated). Thus, the battery module 200 is sealed inside the exterior case 100.

The battery module 200 is accommodated inside the exterior case 100, and generates electric power using the plurality of secondary batteries 210.

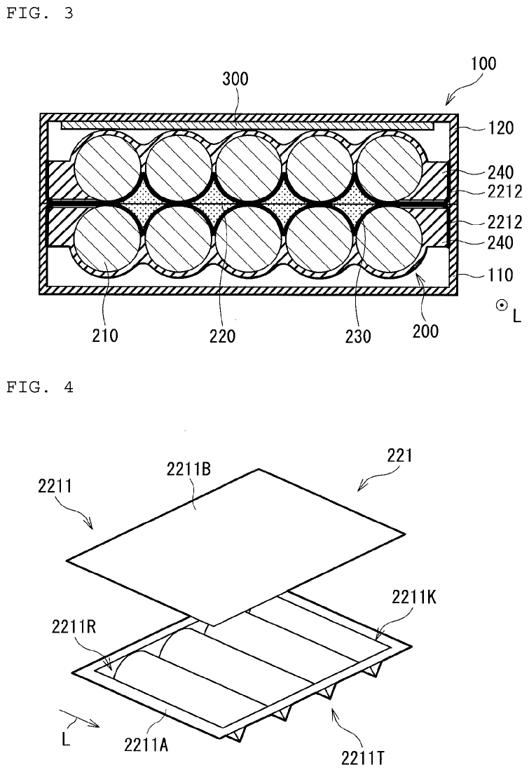

The battery module 200 includes a plurality of secondary batteries 210, a partition plate 220, a heat absorbing agent 230, a battery holder 240, and the like. A detailed configuration of battery module 200 will be described later (see FIGS. 4 to 7).

The control board 300 is a board that controls the operation of the battery pack, and more specifically, is a mounting board on which a plurality of electronic components is mounted. Here, the control board 300 is arranged on the battery module 200 and is connected to each of lead plates 250A and 250F.

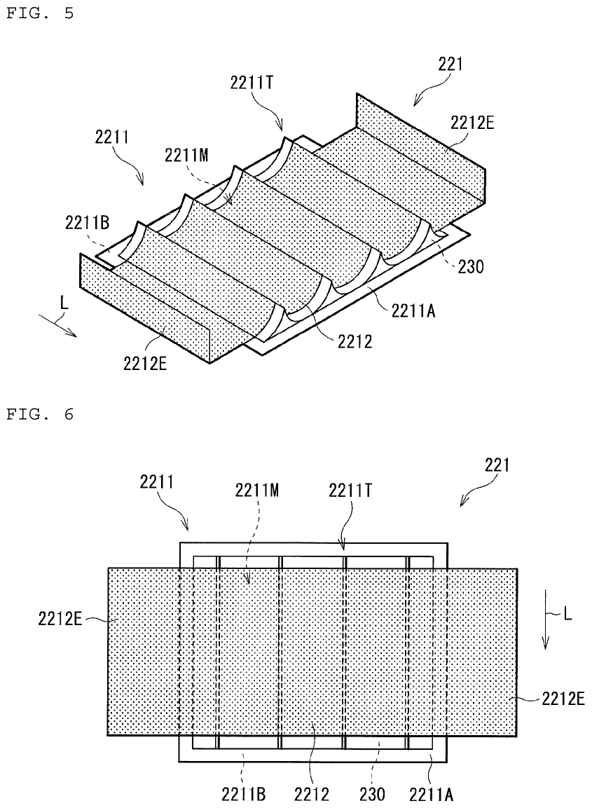

FIGS. 4 and 5 each illustrate a perspective configuration of the partition plate 220 illustrated in FIG. 2. FIG. 6 illustrates a planar configuration of the partition plate 220 illustrated in FIG. 2.

Here, FIG. 4 illustrates a state where a part of the partition plate 220 (lower partition plate 221) is viewed from the top and a state where the lower partition plate 221 is disassembled. FIGS. 5 and 6 each illustrate a state in which the lower partition plate 221 is viewed from the bottom.

As illustrated in FIGS. 1 to 6, the battery module 200 includes the plurality of secondary batteries 210, the partition plate 220, the heat absorbing agent 230, the battery holder 240, and the lead plates 250A to 250F.

As illustrated in FIG. 2, each of the plurality of secondary batteries 210 is a so-called cylindrical lithium ion secondary battery, and extends in the length direction L. The secondary battery 210 has a protruding positive electrode terminal portion 210P that is provided at one end in the length direction L and a non-protruding negative electrode terminal portion 210N that is provided at the other end in the length direction L. The positive electrode terminal portion 210P is a terminal portion having a positive polarity, and the negative electrode terminal portion 210N is a terminal portion having a negative polarity.

A partition plate 220 is arranged between the plurality of secondary batteries 210, and a battery holder 240 is arranged around the plurality of secondary batteries 210. As a result, the plurality of secondary batteries 210 is supported while being isolated from each other by the partition plate 220, and the plurality of secondary batteries 210 and the partition plate 220 are held by the battery holder 240.

The number of the secondary batteries 210 is not particularly limited. Here, the battery module 200 includes ten secondary batteries 210, and the ten secondary batteries 210 are arranged in five columns×two rows as described below.

Two rows of secondary batteries 210 arranged in the first column (the innermost column from the back side) are arranged in such a manner that the positive electrode terminal portions 210P face the side opposed to the lead plates 250A, 250C, and 250E. Two rows of secondary batteries 210 arranged in the second column (the second column from the back side) are arranged in such a manner that the positive electrode terminal portions 210P face the side opposed to the lead plates 250B, 250D, and 250F. Two rows of secondary batteries 210 arranged in the third column (the third column from the back side) are arranged in the same direction as the direction of the two rows of secondary batteries 210 arranged in the first column. Two rows of secondary batteries 210 arranged in the fourth column (the fourth column from the back side) are arranged in the same direction as the direction of the two rows of secondary batteries 210 arranged in the second column. Two rows of secondary batteries 210 arranged in the fifth column (the fifth column from the back side) are arranged in the same direction as the direction of the two rows of secondary batteries 210 arranged in the first column.

Thus, the ten secondary batteries 210 are electrically connected to each other in such a manner of being 2 parallel×5 series with the lead plates 250A to 250F interposed therebetween.

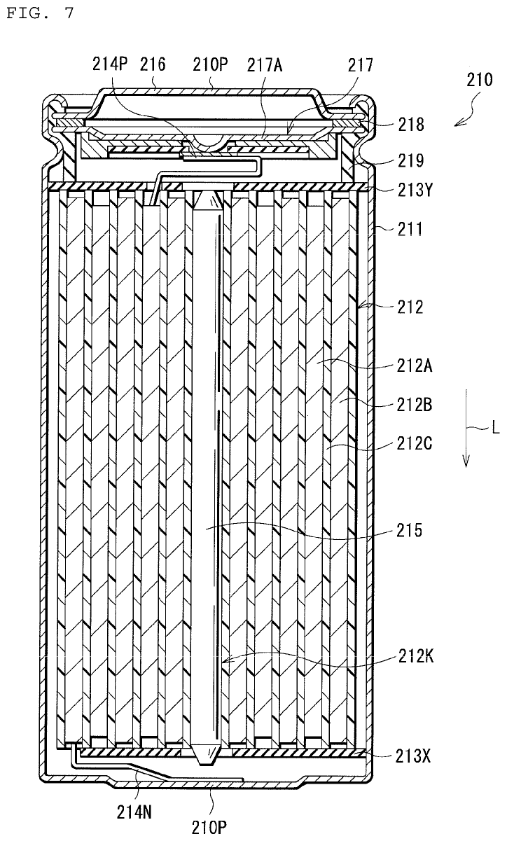

The detailed configuration of the secondary battery 210 (cylindrical lithium ion secondary battery) will be described later (see FIG. 7).

As illustrated in FIGS. 2 to 6, the partition plate 220 is an isolating member arranged between the plurality of secondary batteries 210. Since the partition plate 220 is inserted into a gap provided between the plurality of secondary batteries 210, the plurality of secondary batteries 210 are isolated from each other. Thus, the partition plate 220 supports the plurality of secondary batteries 210 while isolating the plurality of secondary batteries 210 from each other, and thus the distance between the plurality of secondary batteries 210 is maintained to be a predetermined distance by the partition plate 220.

In addition, since the partition plate 220 has a three-dimensional shape corresponding to a gap (space) provided between the plurality of secondary batteries 210, the partition plate is in contact with each of the plurality of secondary batteries 210 in a state of being inserted into the gap. This is because the plurality of secondary batteries 210 is supported while being isolated from each other by the partition plate 220.

The partition plate 220 has a housing space 2211R inside, and the heat absorbing agent 230 is housed in the housing space 2211R. Thus, the partition plate 220 isolates the plurality of secondary batteries 210 from each other in a state where the heat absorbing agent 230 is housed in the housing space 2211R.

Here, the partition plate 220 includes a lower partition plate 221 and an upper partition plate 222 which are separated from each other. The lower partition plate 221 isolates the five secondary batteries 210 arranged in the first row from each other, and the upper partition plate 222 isolates the five secondary batteries 210 arranged in the second row from each other.

As illustrated in FIGS. 2 to 6, the lower partition plate 221 includes a housing cup 2211 and a heat conduction sheet 2212.

The housing cup 2211 is a part of the housing portion that isolates the five secondary batteries 210 arranged in the first row from each other and houses the heat absorbing agent 230 inside, and is arranged between the five secondary batteries 210. The housing cup 2211 includes a cup body 2211A and a sealing sheet 2211B.

The cup body 2211A is a member having a vessel-like structure in which the lower end is closed and the upper end is opened. As a result, the cup body 2211A has an opening 2211K at the upper end, and has a housing space 2211R communicating with the opening 2211K. As described above, the housing space 2211R is a space in which the heat absorbing agent 230 is housed. Here, in FIG. 4, the illustration of the heat absorbing agent 230 is omitted in order to make the internal configuration of the cup body 2211A easy to view.

In addition, the cup body 2211A has a protrusion 2211T and a support surface 2211M in order to support five secondary batteries 210 while isolating the five secondary batteries 210 from each other. Here, as described above, since the lower partition plate 221 supports the five secondary batteries 210 while isolating the five secondary batteries 210 from each other, the cup body 2211A has four protrusions 2211T and five support surfaces 2211M. Thus, the cup body 2211A has a substantially wavy sectional shape defined by the four protrusions 2211T.

The protrusion 2211T is located between two secondary batteries 210 adjacent to each other, and isolates the two secondary batteries 210 from each other. The protrusion 2211T is a downward protruding portion defined by two support surfaces 2211M adjacent to each other. As a result, since a part of the housing space 2211R is provided inside the protrusion 2211T, a part of the heat absorbing agent 230 is housed inside the protrusion 2211T.

Here, as described above, since the secondary battery 210 is a cylindrical lithium ion secondary battery, the support surface 2211M is a concave curved surface facing downward. The support surface 2211M is curved along the outer peripheral surface of the secondary battery 210 and thus the cup body 2211A can support the secondary battery 210.

Each of the four protrusion 2211T and the five support surfaces 2211M is arranged in a direction intersecting the length direction L, that is, in a direction in which the five secondary batteries 210 are arranged.

A material for forming the cup body 2211A is not particularly limited, and can be arbitrarily set. Specifically, the cup body 2211A includes any one or two or more kinds of polymer compounds, and specific examples of the polymer compounds include polyethylene terephthalate (PET), polypropylene (PP), polyethylene (PE), and polyamide.

Here, the material for forming the cup body 2211A preferably has sufficient thermal conductivity. This is because, when the secondary battery 210 generates heat, the heat generated in the secondary battery 210 is more likely to be conducted to the cup body 2211A, and the heat is further more likely to be conducted to the heat conduction sheet 2212 via the cup body 2211A.

The sealing sheet 2211B is a member that closes the opening 2211K of the cup body 2211A, and the cup body 2211A is sealed by the sealing sheet 2211B in a state where the heat absorbing agent 230 is housed in the housing space 2211R.

In order to close the opening 2211K, the sealing sheet 2211B may be fixed to the cup body 2211A using a heat welding method or the like, or may be fixed to the cup body 2211A using an adhesive such as a potting material.

Details regarding the material for forming the sealing sheet 2211B are similar to the details regarding the material for forming the cup body 2211A. Here, the material for forming the cup body 2211A and the material for forming the sealing sheet 2211B may be the same or different from each other.

The heat conduction sheet 2212 is a part of the heat conduction part for heat dissipation that conducts, when the secondary battery 210 generates heat, the heat for heat dissipation, and is attached to the housing cup 2211. In each of FIGS. 5 and 6, the heat conduction sheet 2212 is shaded in order to easily identify the heat conduction sheet 2212.

Note that a method for attaching the heat conduction sheet 2212 to the housing cup 2211 is not particularly limited. Specifically, the heat conduction sheet 2212 may be bonded to the housing cup 2211 by an adhesive or the like, or may be thermally welded to the housing cup 2211.

Since the heat conduction sheet 2212 is fixed to the cup body 2211A on the side where the protrusion 2211T and the support surface 2211M are provided, the heat conduction sheet is arranged between the cup body 2211A and each of the five secondary batteries 210.

In addition, the heat conduction sheet 2212 is arranged along each of the four protrusions 2211T and the five support surfaces 2211M in order to be interposed between the cup body 2211A and each of the five secondary batteries 210. As a result, the heat conduction sheet 2212 extends in a direction intersecting the length direction L, that is, in the same direction as the direction in which the five secondary batteries 210 are arranged.

In this case, since the heat conduction sheet 2212 extends to the outside of the housing cup 2211, it is preferable that the heat conduction sheet includes a lead-out end portion 2212E led out to the outside of the housing cup 2211. This is because the heat conducted to the heat conduction sheet 2212 is more likely to be guided to the outside of the housing cup 2211. Here, in FIG. 4, the heat conduction sheet 2212 is not illustrated.

The number of the lead-out end portions 2212E is not particularly limited, and can be arbitrarily set. Here, since the heat conduction sheet 2212 extends in the direction intersecting the length direction L as described above, the heat conduction sheet 2212 may include only one lead-out end portion 2212E or may include two lead-out end portions 2212E. That is, the heat conduction sheet 2212 may include only the lead-out end portion 2212E which is one end portion, may include only the lead-out end portion 2212E which is the other end portion, or may include both.

In particular, the heat conduction sheet 2212 preferably includes two lead-out end portions 2212E. This is because, since heat is more likely to be smoothly guided to the outside of the housing cup 2211 through the two lead-out end portions 2212E, the heat guidance efficiency is improved. Each of FIGS. 2, 5, and 6 illustrates a case where the heat conduction sheet 2212 includes two lead-out end portions 2212E.

Note that the lead-out end portion 2212E may be bent toward the lower case 110 and thus the entire lower partition plate 221 can be accommodated inside the lower case 110. In this case, the lead-out end portion 2212E may be bent, or the lead-out end portion 2212E may be curved. Here, in order to make the configuration of the heat conduction sheet 2212 easy to view, in FIG. 3, the heat conduction sheet 2212 is indicated by a thick line, and in FIG. 6, a state in which the lead-out end portion 2212E is not bent is illustrated.

Here, as illustrated in each of FIGS. 2 and 3, since the lead-out end portion 2212E is led out to the outside of the battery holder 240 via a lead-out port 240K to be described later, the lead-out end portion 2212E is exposed from the battery holder 240. This is because, the lead-out end portion 2212E is sandwiched between the lower case 110 and the battery holder 240, and therefore the lead-out end portion 2212E is fixed. This is also because the heat conducted to the lead-out end portion 2212E is released to the outside of the battery pack via the lower case 110. In this case, the lead-out end portion 2212E is bent along the inner wall surface of the lower case 110.

Further, the lead-out end portion 2212E is coupled to the inner wall surface of the lower case 110 by being exposed from the battery holder 240. This is because, the lead-out end portion 2212E is more likely to be fixed, and the heat conducted to the lead-out end portion 2212E is more likely to be released to the outside of the battery pack via the lower case 110.

In particular, the heat conduction sheet 2212 has a thermal conductivity higher than the thermal conductivity of the housing cup 2211. This is because when heat generated by heat generation of the secondary battery 210 is conducted to the housing cup 2211, the heat is further conducted to the heat conduction sheet 2212. As a result, the heat generated in the secondary battery 210 is guided to the heat conduction sheet 2212, and thus the heat is less likely to be accumulated in the secondary battery 210. Here, the thermal conductivity described here is a thermal conductivity measured in accordance with JIS A 1412-2.

The material for forming the heat conduction sheet 2212 is not particularly limited as long as it is a material having a thermal conductivity higher than the thermal conductivity of the housing cup 2211. Specifically, the heat conduction sheet 2212 is any one or two or more kinds of a metal sheet, a thermally conductive silicon sheet, a graphite compounding sheet, and the like. Specific examples of the metal sheet include an aluminum foil and a copper foil. Here, the heat conduction sheet 2212 may have conductivity or insulation.

As illustrated in FIGS. 2 to 6, the upper partition plate 222 has a configuration similar to the configuration of the lower partition plate 221 except that the upper partition plate 222 has a configuration vertically inverted from the configuration of the lower partition plate 221.

That is, the upper partition plate 222 isolates the five secondary batteries 210 arranged in the second row from each other and houses the heat absorbing agent 230 inside, and includes the housing cup 2211 (opening 2211K, four protrusions 2211T, five support surfaces 2211M, and housing space 2211R) and the heat conduction sheet 2212 (two lead-out end portions 2212E).

Here, the opening 2211K is provided at the lower end of the cup body 2211A. The protrusion 2211T is an upward projecting portion. The support surface 2211M is a concave curved surface facing upward. The lead-out end portion 2212E may be bent toward the upper case 120.

The lower partition plate 221 and the upper partition plate 222 are arranged in such a manner that the sealing sheets 2211B of the housing cup 2211 face each other and are adjacent to each other.

As illustrated in FIGS. 2 to 6, the heat absorbing agent 230 is housed inside the partition plate 220, more specifically, housed in the housing space 2211R. In FIG. 3, the heat absorbing agent 230 is shaded.

The heat absorbing agent 230 cools the secondary battery 210 which is a heat source by absorbing heat at the time of abnormality occurrence. The “time of abnormality occurrence” is a case where any one or two or more of the plurality of secondary batteries 210 generate heat due to some cause. Here, the heat absorbing agent 230 may be further used for cooling other components (components other than the secondary battery 210) of the battery pack.

The kind of the heat absorbing agent 230 is not particularly limited as long as it is a material capable of cooling the secondary battery 210 heated to a high temperature at the time of abnormality occurrence, that is, a material having a cooling property (heat absorbing property).

Specifically, the heat absorbing agent 230 preferably contains water. This is because excellent fluidity and excellent cooling property can be obtained. In addition, since water has a property of maintaining a temperature of 100° C. at the maximum when being continuously heated (latent heat of vaporization), the temperature of the heat absorbing agent 230 containing the water is less likely to rise excessively.

Note that the heat absorbing agent 230 may be in a liquid state or a gel state as long as it has the fluidity and cooling property described above.

A specific example of the heat absorbing agent 230 in a liquid state is water. In this case, the heat absorbing agent 230 may further contain any one of, or two or more kinds of liquids other than water. Here, the heat absorbing agent 230 containing a liquid other than water together with water preferably contains the water as a main component.

The heat absorbing agent 230 in a gel state is a hydrogel containing water or the like, and the hydrogel may be a biopolymer gel, a synthetic polymer gel, or both. Specific examples of the biopolymer gel are agar and the like. Since the synthetic polymer gel contains a polymer compound together with water, the synthetic polymer gel has a gel state in which water is retained by the polymer compound. The kind of the polymer compound is not particularly limited, and specific examples thereof include sodium polyacrylate (PNaAA), polyvinyl alcohol (PVA), polyhydroxyethyl methacrylate (PHE-MA), and silicone hydrogel.

As illustrated in FIGS. 2 and 3, the battery holder 240 is a holding member arranged around the plurality of secondary batteries 210, and holds the plurality of secondary batteries 210 isolated from each other by the partition plate 220.

The battery holder 240 has a frame structure in which one end and the other end in the length direction L are opened respectively, and has an insertion port 240S into which the secondary battery 210 is inserted. Here, as described above, since the battery pack includes ten secondary batteries 210, the battery holder 240 has ten insertion ports 240S, and the ten insertion ports 240S are coupled to each other.

A material for forming the battery holder 240 is the same as a material for forming the partition plate 220. Here, the material for forming the battery holder 240 and the material for forming the partition plate 220 may be the same or different from each other.

The battery holder 240 is provided with a lead-out port 240K for leading out the lead-out end portion 2212E. Here, since the heat conduction sheet 2212 includes two lead-out end portions 2212E, the battery holder 240 has two lead-out ports 240K.

The specific configuration of the battery holder 240 is not particularly limited as long as the plurality of secondary batteries 210 can be held. Here, in order to hold the plurality of secondary batteries 210 from both sides by using the battery holder 240, the battery holder 240 is divided into two in the length direction L. As a result, ten secondary batteries 210 are held by the two battery holders 240 separated from each other.

The lead plates 250A to 250F are a plurality of connection members for electrically connecting the plurality of secondary batteries 210 to each other, and are coupled to each of the plurality of secondary batteries 210. Here, each of the lead plates 250A to 250F is welded to each of the plurality of secondary batteries 210.

Each of the lead plates 250A and 250F has a substantially plate-like structure connectable to two secondary batteries 210, and each of the lead plates 250B to 250E has a substantially plate-like structure connectable to four secondary batteries 210.

Here, for convenience, as described below, ten secondary batteries 210 are classified by adding alphabets (A to J).

Secondary battery 210 of the first row located in the column on the backmost side: secondary battery 210A

Secondary battery 210 of the second row located in the column on the backmost side: secondary battery 210B Secondary battery 210 of the first row located in the second column from the back side: secondary battery 210C

Secondary battery 210 of the second row located in the second column from the back side: secondary battery 210D

Secondary battery 210 of the first row located in the third column from the back side: secondary battery 210E

Secondary battery 210 of the second row located in the third column from the back side: secondary battery 210F

Secondary battery 210 of the first row located in the fourth column from the back side: secondary battery 210G

Secondary battery 210 of the second row located in the fourth column from the back side: secondary battery 210H

Secondary battery 210 of the first row located in the fifth column from the back side: secondary battery 210I

Secondary battery 210 of the second row located in the fifth column from the back side: secondary battery 210J

In this case, ten secondary batteries 210 are electrically connected to each other in such a manner of being 2 parallel×5 series with the lead plates 250A to 250F interposed therebetween by a connection type described below.

The positive electrode terminal portion 210P of each of the secondary batteries 210A and 210B is connected to the lead plate 250A, and the negative electrode terminal portion 210N of each of the secondary batteries 210A and 210B is connected to the lead plate 250B. The positive electrode terminal portion 210P of each of the secondary batteries 210C and 210D is connected to the lead plate 250B, and the negative electrode terminal portion 210N of each of the secondary batteries 210C and 210D is connected to the lead plate 250C. The positive electrode terminal portion 210P of each of the secondary batteries 210E and 210F is connected to the lead plate 250C, and the negative electrode terminal portion 210N of each of the secondary batteries 210E and 210F is connected to the lead plate 250D.

The positive electrode terminal portion 210P of each of the secondary batteries 210G and 210H is connected to the lead plate 250D, and the negative electrode terminal portion 210N of each of the secondary batteries 210G and 210H is connected to the lead plate 250E. The positive electrode terminal portion 210P of each of the secondary batteries 210I and 210J is connected to the lead plate 250E, and the negative electrode terminal portion 210N of each of the secondary batteries 210I and 210F is connected to the lead plate 250F.

FIG. 7 illustrates an enlarged sectional configuration of the secondary battery 210 illustrated in FIG. 2. As described above, the secondary battery 210 is a cylindrical lithium ion secondary battery, and includes an electrolytic solution which is a liquid electrolyte together with the positive electrode 212A and the negative electrode 212B.

In the secondary battery 210, the charge capacity of the negative electrode 212B is larger than the discharge capacity of the positive electrode 212A. That is, the electrochemical capacity per unit area of the negative electrode 212B is set to be larger than the electrochemical capacity per unit area of the positive electrode 212A. This is to prevent the electrode reactant from precipitating on the surface of the negative electrode 212B during charging.

Specifically, as illustrated in FIG. 7, the secondary battery 210 includes a battery can 211, a battery element 212, a pair of insulating plates 213X and 213Y, a positive electrode lead 214P, and a negative electrode lead 214N.

The battery can 211 is a first exterior member that accommodates the battery element 212 and the like inside. Since the battery can 211 has a vessel-like structure in which one end is closed and the other end is opened, the other end has an open end portion. In addition, the battery can 211 contains a conductive material such as iron, and a metal material such as nickel may be plated on the surface of the battery can 211. The insulating plates 213X and 213Y are arranged in such a manner of facing each other with the battery element 212 interposed therebetween.

Since the battery can 211 is electrically connected to either the positive electrode lead 214P or the negative electrode lead 214N, the battery can 211 has positive or negative polarity. Here, the battery can 211 has a negative polarity because it is electrically connected to the negative electrode lead 214N as described later.

A battery cover 216, a safety valve mechanism 217, and a heat sensitive resistance element (so-called PTC element) 218 are crimped to the open end portion of the battery can 211 with a gasket 219 interposed therebetween. As a result, the battery can 211 is sealed by the battery cover 216, and the battery cover 216 is fixed to the battery can 211. Here, the battery cover 216 contains the same material as the material for forming the battery can 211. Each of the safety valve mechanism 217 and the PTC element 218 is provided inside the battery cover 216, and the safety valve mechanism 217 is electrically connected to the battery cover 216 via the PTC element 218. The gasket 219 contains an insulating material, and asphalt or the like may be applied to the surface of the gasket 219.

In the safety valve mechanism 217, when the internal pressure of the battery can 211 reaches a certain level or more due to an internal short circuit or the like, a disk plate 217A is reversed, and thus the electrical connection between the battery element 212 and the battery cover 216 is disconnected. In order to prevent abnormal heat generation due to a large current, the electrical resistance of the PTC element 218 rises as the temperature rises.

The battery element 212 is a power generating element including a positive electrode 212A, a negative electrode 212B, a separator 212C, and an electrolytic solution (not illustrated).

The battery element 212 is a so-called wound electrode body. That is, the positive electrode 212A and the negative electrode 212B are wound while facing each other with the separator 212C interposed therebetween. A center pin 215 is inserted into a winding center space 212K provided at the winding center of the battery element 212, and the center pin 215 may be omitted.

The positive electrode 212A includes a positive electrode current collector and a positive electrode active material layer (not illustrated).

The positive electrode current collector contains a conductive material such as aluminum. The positive electrode active material layer is provided on both surfaces of the positive electrode current collector, and contains any one or two or more kinds of positive electrode active materials that occlude and release lithium ions. Here, the positive electrode active material layer may further contain any one or two or more kinds of other materials such as a positive electrode binder and a positive electrode conductive agent.

The kind of the positive electrode active material is not particularly limited, and is specifically a lithium-containing compound. This lithium-containing compound is a compound containing one or two or more kinds of transition metal elements as constituent elements together with lithium, and specific examples thereof include an oxide, a phosphoric acid compound, a silicic acid compound, and a boric acid compound. Specific examples of the oxide include LiNiO₂, LiCoO₂, LiMn₂O₄, and the like, and specific examples of the phosphoric acid compound include LiFePO₄, LiMnPO₄, and the like.

The positive electrode binder is one or both of a synthetic rubber and a polymer compound. Specific examples of the synthetic rubber are styrene butadiene-based rubber and the like, and specific examples of the polymer compound are polyvinylidene fluoride and the like. The positive electrode conductive agent is any one or two or more kinds of conductive materials such as a carbon material, a metal material, and a conductive polymer compound, and specific examples of the carbon material are graphite and the like.

The negative electrode 212B includes a negative electrode current collector and a negative electrode active material layer (not illustrated).

The negative electrode current collector contains a conductive material such as copper. The negative electrode active material layer is provided on both surfaces of the negative electrode current collector, and contains any one or two or more kinds of negative electrode active materials that occlude and release lithium ions. Here, the negative electrode active material layer may further contain any one or two or more kinds of other materials such as a negative electrode binder and a negative electrode conductive agent.

The kind of the negative electrode active material is not particularly limited, and specific examples thereof include a carbon material, a metal-based material, and the like. Specific examples of the carbon material include graphite (natural graphite or artificial graphite) and the like. The metal-based material is a material including any one kind or two or more kinds of metal elements and metalloid elements capable of forming an alloy with lithium as constituent elements, and specific examples of the metal elements and metalloid elements are silicon, tin, and the like. The metal-based material may be a simple substance, an alloy, a compound, a mixture of two or more thereof, or a material including two or more phases thereof. Specific examples of the metal-based material include TiSi₂, SiOₓ (0<x≤2 or 0.2<x<1.4), and the like. Details regarding each of the negative electrode binder and the negative electrode conductive agent are the same as the details regarding each of the positive electrode binder and the positive electrode conductive agent.

The separator 212C is an insulating porous film interposed between the positive electrode 212A and the negative electrode 212B, and allows lithium ions to pass therethrough while preventing contact (short circuit) between the positive electrode 212A and the negative electrode 212B. The separator 212C contains a polymer compound such as polyethylene.

The electrolytic solution impregnates each of the positive electrode 212A, the negative electrode 212B, and the separator 212C, and contains a solvent and an electrolyte salt.

Here, the solvent contains any one or two or more kinds of non-aqueous solvents (organic solvents), and the electrolytic solution containing the non-aqueous solvent is a so-called non-aqueous electrolytic solution.

The non-aqueous solvent contains any one or two or more kinds of a cyclic carbonate ester, a chain carbonate ester, a chain carboxylate ester, a lactone, and the like. Specific examples of the cyclic carbonate ester include ethylene carbonate, propylene carbonate, and the like. Specific examples of the chain carbonate ester include dimethyl carbonate, diethyl carbonate, ethyl methyl carbonate, and the like. Specific examples of the chain carboxylic acid ester include ethyl acetate, ethyl propionate, propyl propionate, and the like. Specific examples of the lactone include γ-butyrolactone, γ-valerolactone, and the like.

The electrolyte salt is a light metal salt such as a lithium salt. Specific examples of the lithium salt include lithium hexafluorophosphate (LiPF₆), lithium tetrafluoroborate (LiBF₄), lithium bis (fluorosulfonyl) imide (LiN(FSO₂)₂), and lithium bis (trifluoromethanesulfonyl) imide (LiN(CF₃SO₂)₂).

The content of the electrolyte salt is not particularly limited, and is specifically 0.3 mol/kg to 3.0 mol/kg inclusive with respect to the solvent. This is because high ion conductivity can be obtained.

The positive electrode lead 214P is connected to the positive electrode current collector of the positive electrode 212A and contains a conductive material such as aluminum. The positive electrode lead 214P is electrically connected to the battery cover 216 via the safety valve mechanism 217.

The negative electrode lead 214N is connected to the negative electrode current collector of the negative electrode 212B and contains a conductive material such as nickel. The negative electrode lead 214N is electrically connected to the battery can 211.

Hereinafter, the operation at the time of charging and discharging will be described, and then the operation at the time of abnormality occurrence will be described.

At the time of charging, in each of the plurality of secondary batteries 210 mounted on the battery module 200, lithium ions are released from the positive electrode 212A, and the lithium ions are occluded in the negative electrode 212B through the electrolytic solution.

On the other hand, at the time of discharging, in each of the plurality of secondary batteries 210, lithium ions are released from the negative electrode 212B, and the lithium ions are occluded in the positive electrode 212A through the electrolytic solution.

As described above, the heat absorbing agent 230 is housed in the housing space 2211R provided in the partition plate 220.

When any one of the plurality of secondary batteries 210 generates heat due to some cause, since the plurality of secondary batteries 210 are isolated from each other with the partition plate 220 interposed therebetween, the heat generated in the secondary battery 210 which is a heat source is less likely to be conducted to the other five secondary batteries 210.

Moreover, when any one secondary battery 210 generates heat, the heat absorbing agent 230 cools the secondary battery 210 which is a heat source while absorbing heat via the partition plate 220 (the housing cup 2211 and the heat conduction sheet 2212). In addition, since the heat generated in the secondary battery 210 which is a heat source is conducted to the heat conduction sheet 2212, the heat is less likely to be accumulated in the secondary battery 210 which is the heat source.

Note that the heat conducted to the heat conduction sheet 2212 is released from the lead-out end portion 2212E to the outside of the battery pack via the exterior case 100.

From these, at the time of abnormality occurrence due to heat generation of the secondary battery 210, the heat absorbing agent 230 housed in the housing cup 2211 cools the secondary battery 210 which is a heat source while suppressing conduction of heat from the secondary battery 210 which is the heat source to the other secondary batteries 210, and the heat is released to the outside of the battery pack. As a result, the progress of an excessive exothermic reaction in the secondary battery 210 which is a heat source is suppressed, and an excessive temperature rise in the battery pack is suppressed.

Note that, here, the case where the abnormality (heat generation) occurs in any one secondary battery 210 among the plurality of secondary batteries 210 has been described. However, in a case where an abnormality occurs in any two or more of the plurality of secondary batteries 210, the above-described operation at the time of abnormality occurrence is similarly performed for each secondary battery 210 which is a heat source. As a result, in the entire battery pack, the progress of an excessive exothermic reaction is suppressed, and an excessive temperature rise is suppressed.

Hereinafter, an example of a manufacturing procedure of a battery pack including ten secondary batteries 210 will be described with reference to FIGS. 1 to 7.

In the case of manufacturing a battery pack, first, the secondary battery 210 is prepared as illustrated in FIG. 7.

In the case of preparing the secondary battery 210, first, a positive electrode 212A is prepared by forming a positive electrode active material layer on both surfaces of a positive electrode current collector, and a negative electrode 212B is prepared by forming a negative electrode active material layer on both surfaces of a negative electrode current collector. In this case, a positive electrode mixture slurry containing a positive electrode active material, a solvent, and the like is produced, and then the positive electrode mixture slurry is applied to both surfaces of the positive electrode current collector, and a negative electrode mixture slurry containing a negative electrode active material, a solvent, and the like is produced, and then the negative electrode mixture slurry is applied to both surfaces of the negative electrode current collector. The kind of the solvent is not particularly limited, and may be an aqueous solvent or an organic solvent.

Subsequently, the positive electrode lead 214P is connected to the positive electrode current collector of the positive electrode 212A by a joining method such as a welding method, and the negative electrode lead 214N is connected to the negative electrode current collector of the negative electrode 212B by a joining method such as a welding method.

Subsequently, the positive electrode 212A and the negative electrode 212B are stacked with the separator 212C interposed therebetween, and then the positive electrode 212A, the negative electrode 212B, and the separator 212C are wound to prepare a wound body (not illustrated) having the winding center space 212K. This wound body has the same configuration as the configuration of the battery element 212 except that each of the positive electrode 212A, the negative electrode 212B, and the separator 212C is not impregnated with the electrolytic solution. Subsequently, the center pin 215 is inserted into the winding center space 212K.

Subsequently, while the wound body is sandwiched between the insulating plates 213X and 213Y, the insulating plates 213X and 213Y and the wound body are accommodated inside the battery can 211. In this case, the positive electrode lead 214P is connected to the safety valve mechanism 217 by a joining method such as a welding method, and the negative electrode lead 214N is connected to the battery can 211 by a joining method such as a welding method. Subsequently, the electrolytic solution is injected into the battery can 211. As a result, each of the positive electrode 212A, the negative electrode 212B, and the separator 212C is impregnated with the electrolytic solution, and thus the battery element 212 is prepared.

Finally, the battery cover 216, the safety valve mechanism 217, and the PTC element 218 are accommodated inside the battery can 211, and then the battery can 211 is crimped with the gasket 219 interposed therebetween. As a result, the battery can 211 is sealed by the battery cover 216, and thus the secondary battery 210 is completed.

Next, as illustrates in FIGS. 4 to 6, the partition plate 220 (the lower partition plate 221 and the upper partition plate 222) housing the heat absorbing agent 230 is prepared. Here, a method of preparing the lower partition plate 221 will be described, and a method of manufacturing the upper partition plate 222 is the same as the method of manufacturing the lower partition plate 221. Therefore, a description of a method of forming the upper partition plate 222 is omitted.

In the case of preparing the lower partition plate 221, first, the cup body 2211A having the opening 2211K, four protrusions 2211T, five support surfaces 2211M, and the housing space 2211R is formed using any one or two or more kinds of molding methods such as an injection molding method and an extrusion molding method. Here, as a method of forming the cup body 2211A, a shaving method may be used instead of the molding method.

Subsequently, the heat conduction sheet 2212 is attached to the cup body 2211A using an adhesive. As the adhesive, a thermally conductive adhesive is preferably used. This is because the thermal conductivity between the cup body 2211A and the heat conduction sheet 2212 is improved.

Finally, the heat absorbing agent 230 is injected into the housing space 2211R from the opening 2211K, and then the opening 2211K is closed using the sealing sheet 2211B. In this case, the sealing sheet 2211B is attached to the cup body 2211A using an adhesive. The details of the metal salt are as described above. As a result, the housing cup 2211 including the cup body 2211A and the sealing sheet 2211B is formed. Here, the sealing sheet 2211B may be thermally welded to the cup body 2211A without using an adhesive.

In this case, both end portions (lead-out end portions 2212E) of the heat conduction sheet 2212 are led out to the outside of the housing cup 2211, and a portion other than both end portions of the heat conduction sheet 2212 is along each of the four protrusions 2211T and the five support surfaces 2211M.

Therefore, since the heat absorbing agent 230 is sealed in the housing space 2211R, the lower partition plate 221 including the housing cup 2211 and the heat conduction sheet 2212 is prepared.

Next, as illustrated in FIG. 2, a battery module 200 is prepared using ten secondary batteries 210 and the partition plate 220 (lower partition plate 221 and upper partition plate 222).

In the case of preparing the battery module 200, first, five secondary batteries 210 are arranged in five columns, and then the lower partition plate 221 is inserted into a gap provided between the five secondary batteries 210. Subsequently, the remaining five secondary batteries 210 are arranged in five columns, and then the upper partition plate 222 is inserted into a gap provided between the five secondary batteries 210. As a result, the five secondary batteries 210 are supported while being isolated from each other by the lower partition plate 221, and the five secondary batteries 210 are supported while being isolated from each other by the upper partition plate 222.

Subsequently, the lower partition plate 221 and the upper partition plate 222 are adjacent to each other in such a manner that the sealing sheets 2211B of the housing cup 2211 face each other. Subsequently, the partition plate 220 (lower partition plate 221 and upper partition plate 222) is inserted together with the ten secondary batteries 210 into ten insertion ports 240S provided in the battery holder 240. As a result, in a state where the ten secondary batteries 210 are isolated from each other by the partition plate 220, the 10 secondary batteries 210 are held by the battery holder 240. In this case, the lead-out end portion 2212E of the heat conduction sheet 2212 is led out from the lead-out port 240K provided in the battery holder 240, and then the lead-out end portion 2212E is bent.

Finally, by connecting the lead plates 250A to 250F to the ten secondary batteries 210, the ten secondary batteries 210 are electrically connected to each other in such a manner of being 2 parallel×5 series using the lead plates 250A to 250F. The connection form of the ten secondary batteries 210 using the lead plates 250A to 250F is as described above.

As a result, the ten secondary batteries 210 are held by the battery holder 240 while being isolated from each other by the partition plate 220, and the ten secondary batteries 210 are electrically connected to each other, and thus the battery module 200 is completed.

Finally, as illustrated in FIGS. 1 and 2, a battery pack is assembled.

In a case where the battery pack is assembled, first, the control board 300 is arranged on the battery module 200, and then the control board 300 is connected to the battery module 200. In this case, as described above, the plurality of secondary batteries 210 is connected to the control board 300 with the lead plates 250A and 250F interposed therebetween.

Subsequently, the battery module 200 to which the control board 300 is connected is accommodated inside the lower case 110 from the opening 110K.

Finally, the upper case 120 is arranged on the lower case 110, and then the upper case 120 is fixed to the lower case 110 using a fixing screw (not illustrated).

As a result, the exterior case 100 including the lower case 110 and the upper case 120 is formed, and the battery module 200 is sealed inside the exterior case 100, and thus the battery pack is completed.

According to this battery pack, the partition plate 220 isolates the plurality of secondary batteries 210 from each other, and the heat absorbing agent 230 is housed inside the partition plate 220. In addition, the partition plate 220 includes the housing cup 2211 and the heat conduction sheet 2212, the housing cup 2211 houses the heat absorbing agent 230 inside, and the heat conduction sheet 2212 arranged between the housing cup 2211 and each of the plurality of secondary batteries 210 has a thermal conductivity higher than the thermal conductivity of the housing cup 2211.

In this case, as described above, at the time of abnormality occurrence due to heat generation of an arbitrary secondary battery 210, the following effects can be obtained. First, since the plurality of secondary batteries 210 are isolated from each other with the partition plate 220 interposed therebetween, heat generated in the secondary batteries 210 which is a heat source is less likely to be conducted to the other five secondary batteries 210. Secondly, since the heat absorbing agent 230 is housed inside the partition plate 220, the secondary battery 210 which is a heat source is cooled by the heat absorbing agent 230. Third, since the heat generated in the secondary battery 210 is conducted to the heat conduction sheet 2212, the heat is less likely to be accumulated in the secondary battery 210 which is a heat source.

Therefore, the progress of an excessive exothermic reaction in the secondary battery 210 which is a heat source is suppressed, and an excessive temperature rise in the battery pack is suppressed, and thus excellent safety can be obtained. As a result, thermal runaway of the secondary battery 210 due to the progress of the excessive exothermic reaction is prevented, and damage of the battery pack due to the thermal runaway of the secondary battery 210 is also prevented. In addition, it is also possible to prevent the user from getting injured (such as burning) due to an excessive temperature rise at the time of using or operating the battery pack.

In the battery pack described here, as described above, the following advantages can also be obtained depending on the fact that excellent safety is obtained.

The control board 300 mounted on the battery pack has a so-called protective function. Specifically, the control board 300 stops charging and discharging of the secondary battery 210 when the internal temperature of the battery pack rises to a predetermined temperature or higher, and then restarts charging and discharging of the secondary battery 210 when the internal temperature of the battery pack drops to a predetermined temperature or lower. As a result, when the internal temperature of the battery pack rises due to heat generation of the secondary battery 210, if a long time is required until the internal temperature drops, a long time is required until charging and discharging of the secondary battery 210 is restarted. Therefore, continuous use of the battery pack becomes difficult, and convenience at the time of using the battery pack is deteriorated.

In particular, the water contained in the heat absorbing agent 230 has a property of being less likely to be cooled once heated due to the latent heat of vaporization described above. As a result, when the temperature of the heat absorbing agent 230 rises at the time of abnormality occurrence, the internal temperature is less likely to drop due to a decrease in cooling performance of the heat absorbing agent 230, and therefore it takes a significantly long time until charging and discharging of the secondary battery 210 is restarted.

However, as described above, in the battery pack that can obtain excellent safety, when the internal temperature of the battery pack rises, the secondary battery 210 is still cooled using the heat absorbing agent 230, and the heat generated in the secondary battery 210 is dispersed without being accumulated, and therefore the internal temperature is more likely to decrease in a short time. As a result, when the internal temperature of the battery pack rises due to heat generation of the secondary battery 210, it does not take a long time to restart charging and discharging of the secondary battery 210. Therefore, since the battery pack can be continuously used, convenience at the time of using the battery pack is improved.

In particular, as long as the heat conduction sheet 2212 includes the lead-out end portion 2212E, the heat conducted to the heat conduction sheet 2212 is more likely to be guided to the outside of the housing cup 2211. Therefore, the heat generated in the secondary battery 210 is further more likely to be dispersed without being accumulated, and thus a more excellent effect can be obtained.

In addition, as long as the heat absorbing agent 230 contains water, the heat absorbing agent 230 obtains an excellent fluidity and an excellent cooling property. Therefore, since the cooling efficiency of the heat absorbing agent 230 is improved, a more excellent effect can be obtained.

In addition, when the lead-out end portion 2212E is exposed to the outside of the battery holder 240, the heat conducted to the heat conduction sheet 2212 is more likely to be released from the lead-out end portion 2212E to the outside of the battery holder 240. Therefore, the heat generated in the secondary battery 210 is further more likely to be dispersed without being accumulated, and thus a more excellent effect can be obtained.

In this case, as long as the lead-out end portion 2212E exposed from the battery holder 240 is coupled to the exterior case 100, heat is further more likely to be released from the lead-out end portion 2212E to the outside of the battery holder 240, and thus a more excellent effect can be obtained.

In addition, as long as the battery pack includes the plurality of secondary batteries 210, when charging and discharging are repeated in the battery pack, progress of an excessive exothermic reaction in the secondary battery 210 which is a heat source is sufficiently suppressed, and an excessive temperature rise in the battery pack is sufficiently suppressed, and thus a more excellent effect can be obtained.

The configuration of the battery pack described herein can be appropriately modified including as described below according to an embodiment. Any two or more of a series of modification examples described below may be combined with each other.

The configuration of the lower partition plate 221 illustrated in FIGS. 2 to 6 can be arbitrarily changed as long as the secondary battery 210, which is a heat source, can be cooled using the heat absorbing agent 230 at the time of abnormality occurrence.

Specifically, in each of FIGS. 5 and 6, the heat conduction sheet 2212 has two lead-out end portions 2212E. However, as described above, the heat conduction sheet 2212 may have only one lead-out end portion 2212E.

In FIG. 2, the partition plate 220 includes the lower partition plate 221 and the upper partition plate 222 which are separated from each other. However, since the lower partition plate 221 and the upper partition plate 222 are coupled to each other, they may be integrated with each other.

In this case, the sealing sheet 2211B may be omitted in each of the lower partition plate 221 and the upper partition plate 222. That is, since the cup body 2211A of the lower partition plate 221 and the cup body 2211A of the upper partition plate 222 are coupled to each other, the housing space 2211R of the lower partition plate 221 and the housing space 2211R of the upper partition plate 222 may be sealed without using the sealing sheet 2211B.

In FIG. 2, the battery holder 240 is two members separated from each other. However, the battery holder 240 may be one member that is not separated from each other.

In these cases, the progress of the excessive exothermic reaction of the secondary battery 210 is still suppressed using the heat absorbing agent 230, and the excessive temperature rise of the battery pack is still suppressed using the heat conduction sheet 2212, and thus excellent safety can be obtained.

The configuration of the heat conduction sheet 2212 illustrated in FIG. 6 can be arbitrarily changed as long as the secondary battery 210 which is a heat source can be cooled using the heat absorbing agent 230 at the time of abnormality occurrence.

Specifically, the heat conduction sheet 2212 may be divided into a plurality of pieces. In this case, the dividing direction and the dividing number of the heat conduction sheet 2212 are not particularly limited, and can be arbitrarily set.

More specifically, as illustrated in FIG. 8 corresponding to FIG. 6, the heat conduction sheet 2212 may be divided into two in the length direction L, and the heat conduction sheet 2212 divided into the two may be isolated from each other.

Further, a portion of the heat conduction sheet 2212 may be opened. In this case, the number, position, and shape of the openings are not particularly limited, and can be arbitrarily set.

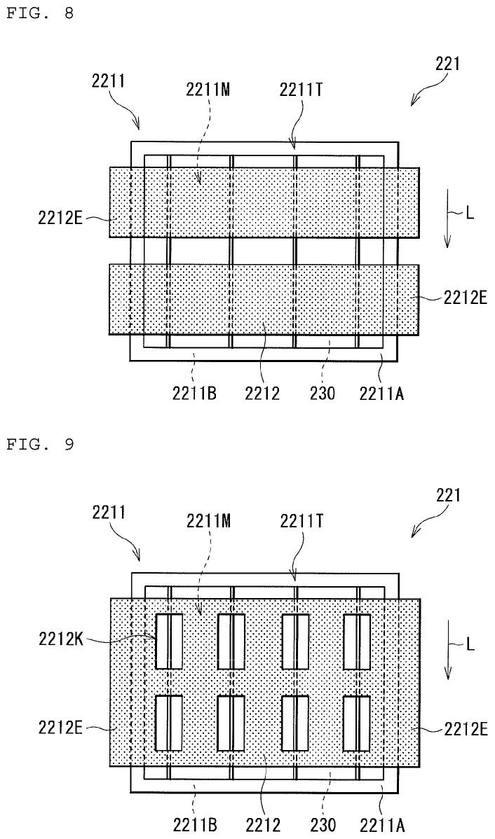

More specifically, as illustrated in FIG. 9 corresponding to FIG. 6, the heat conduction sheet 2212 may have one or two or more openings 2212K. FIG. 9 illustrates a case where the heat conduction sheet 2212 has eight openings 2212K, and the shape of each opening 2212K is rectangular.

In these cases, the progress of the excessive exothermic reaction of the secondary battery 210 is still suppressed using the heat absorbing agent 230, and the excessive temperature rise of the battery pack is still suppressed using the heat conduction sheet 2212, and thus excellent safety can be obtained.

In particular, in a case where the plurality of divided heat conduction sheets 2212 is isolated from each other (FIG. 8), the housing cup 2211 housing the heat absorbing agent 230 is exposed at a place where the heat conduction sheet 2212 does not exist. Therefore, since the cooling efficiency of the secondary battery 210 using the heat absorbing agent 230 is improved by the absence of the heat conduction sheet 2212 between the secondary battery 210 and the housing cup 2211, a more excellent effect can be obtained.

In addition, in a case where the heat conduction sheet 2212 has the opening 2212K (FIG. 9), similarly, the cooling efficiency of the secondary battery 210 using the heat absorbing agent 230 is improved in response to the exposure of the housing cup 2211 at the opening 2212K, and thus a more excellent effect can be obtained.

In a case where the heat conduction sheet 2212 is divided into a plurality of pieces (FIG. 8) or in a case where the heat conduction sheet 2212 has a plurality of openings 2212K (FIG. 9), the housing cup 2211 preferably contains a thermoplastic resin, and more specifically, the housing cup is preferably meltable in a temperature range of the battery pack at the time of abnormality occurrence. The time of abnormality occurrence described here includes not only a case where the secondary battery 210 generates heat but also a case where the secondary battery 210 ignites. The melting temperature of the housing cup 2211 corresponds to the temperature range of the battery pack at the time of abnormality occurrence, and is specifically about 120° ° C. to 270° C. inclusive.

The reason why the housing cup 2211 is meltable is that the heat absorbing agent 230 is released to the outside by using the melting of the housing cup 2211 at the time of abnormality occurrence. As a result, when an abnormality occurs due to ignition of the secondary battery 210, the heat absorbing agent 230 housed inside the housing cup 2211 (housing space 2211R) is released toward the secondary battery 210 which is an ignition source, and thus the secondary battery 210 is cooled and extinguished.

Note that in a case where the housing cup 2211 meltable, the cup body 2211A may be meltable, the sealing sheet 2211B may be meltable, or both may be meltable. Above all, it is preferable that at least the cup body 2211A is meltable. This is because, since the cup body 2211A is arranged closer to the secondary battery 210 than the sealing sheet 2211B, the heat absorbing agent 230 is more likely to be released toward the secondary battery 210.

The housing cup 2211 contains any one or two or more kinds of materials that is meltable in the temperature range (120° C. to 270° ° C. inclusive) of the battery pack at the time of abnormality occurrence described above. The kind of the material is not particularly limited, but among them, a polymer compound is preferable. This is because excellent moldability and melting property can be obtained.

Specific examples of the polymer compound include polyethylene terephthalate, polypropylene, polyethylene, and polyamide described above.

In addition, a specific example of the polymer compound may be an amorphous engineering plastic. The kind of the amorphous engineering plastics is not particularly limited, and specific examples thereof include a polycarbonate and a modified polyphenylene ether. In a case where the polymer compound is the amorphous engineering plastic, the physical (mechanical) strength and rigidity of the housing cup 2211 at the normal time are improved, and thus the housing cup 2211 is less likely to be damaged in response to vibration, impact, or the like. As a result, the heat absorbing agent 230 is less likely to be released to the outside at the normal time while the melting property of the housing cup 2211 at the time of abnormality occurrence is secured. That is, the heat absorbing agent 230 is more likely to be released to the outside only when necessary (at the time of abnormality occurrence).

Here, the kind of the polymer compound as the material for forming the cup body 2211A and the kind of the polymer compound as the material for forming the sealing sheet 2211B may be the same as or different from each other.

Note that at the time of abnormality occurrence, only the cup body 2211A in contact with the heat conduction sheet 2212 may be melted as described above. In this case, as long as the cup body 2211A is meltable, the sealing sheet 2211B may not be meltable.

In a case where the housing cup 2211 is meltable, among them, the heat absorbing agent 230 is preferably in a gel state. This is because the viscosity of the heat absorbing agent 230 increases. As a result, when the heat absorbing agent 230 is released toward the secondary battery 210 at the time of abnormality occurrence, a state in which the heat absorbing agent 230 adheres to the secondary battery 210 is more likely to be maintained. Therefore, since the heat absorbing agent 230 is less likely to fall off from the secondary battery 210, the secondary battery 210 is more likely to be cooled and extinguished by the heat absorbing agent 230.

The gel-like heat absorbing agent 230 is preferably a synthetic polymer gel, and more preferably contains sodium polyacrylate as a polymer compound. This is because, since sodium polyacrylate has high viscosity, when the heat absorbing agent 230 adheres to the secondary battery 210, the heat absorbing agent 230 is less likely to flow down from the secondary battery 210. In addition, this is because, since the viscosity of the heat absorbing agent 230 is less likely to decrease over time, the viscosity of the heat absorbing agent 230 is more likely to be maintained. As a result, the secondary battery 210 is efficiently cooled and extinguished using the heat absorbing agent 230.

In addition, in a case where the heat conduction sheet 2212 has a plurality of openings 2212K and the housing cup 2211 is meltable, among others, each of the plurality of openings 2212K is preferably arranged at a position overlapping the protrusion 2211T. This is because a large amount of the heat absorbing agent 230 is more likely to be released toward the secondary battery 210 at the time of abnormality occurrence, and thus the secondary battery 210 is more likely to be efficiently cooled and extinguished.

Specifically, in the place of the partition plate 220 where the protrusion 2211T is not provided, the housing space 2211R is not expanded, and thus the housing amount of the heat absorbing agent housed in the housing space 2211R is reduced. As a result, the release amount of the heat absorbing agent 230 released toward the secondary battery 210 is reduced, and thus the secondary battery 210 may be less likely to be efficiently cooled and extinguished.

On the other hand, in the place of the partition plate 220 where the protrusion 2211T is provided, the housing space 2211R is expanded, and thus the housing amount of the heat absorbing agent 230 housed in the housing space 2211R is increased. This increases the release amount of the heat absorbing agent 230 released toward the secondary battery 210, and thus the secondary battery 210 is more likely to be efficiently cooled and extinguished.

Here, as illustrated in FIG. 9, since the housing cup 2211 has four protrusions 2211T, the heat conduction sheet 2212 has openings 2212K that are twice as many as four. Specifically, since two openings 2212K are arrange for one protrusion 2211T, the heat conduction sheet 2212 has a total of eight openings 2212K.

In this battery pack, when an abnormality occurs due to ignition of any one secondary battery 210, the housing cup 2211 is heated in response to heat generated in the secondary battery 210. As a result, since the temperature of the housing cup 2211 rises, when the temperature of the housing cup 2211 reaches the melting temperature (melting point), the housing cup 2211 is intentionally melted.

In this case, since an open port (not illustrated) is formed in the housing cup 2211 due to melting, the heat absorbing agent 230 housed in the housing space 2211R is released to the outside from the open port. As a result, the heat absorbing agent 230 is supplied to the secondary battery 210 which is an ignition source through a place where the heat conduction sheet 2212 does not exist. Therefore, since the secondary battery is cooled and extinguished by the heat absorbing agent 230, the progress of excessive ignition in the secondary battery 210 is suppressed. That is, spread of fire and the like of the plurality of secondary batteries 210 is prevented.

In particular, when the heat absorbing agent 230 adheres to the secondary battery 210 which is an ignition source, water in the heat absorbing agent 230 evaporates, and thus water vapor is generated. As a result, the secondary battery 210 is cooled by water vapor, and the secondary battery 210 is effectively extinguished by the water vapor.

Note that, here, a case where ignition occurs in any one secondary battery 210 among the plurality of secondary batteries 210 has been described. However, in a case where ignition occurs in any two or more secondary batteries 210 among the plurality of secondary batteries 210, the above-described operation at the time of abnormality occurrence is similarly performed for each secondary battery 210 which is an ignition source.

In this case, the progress of the excessive exothermic reaction of the secondary battery 210 is still suppressed using the heat absorbing agent 230, and the excessive temperature rise of the battery pack is still suppressed using the heat conduction sheet 2212, and thus excellent safety can be obtained.

In particular, when an abnormality due to ignition of the secondary battery 210 occurs, the heat absorbing agent 230 is supplied to the secondary battery 210 which is an ignition source using melting of the housing cup 2211, and thus the secondary battery 210 is cooled and extinguished by the heat absorbing agent 230. Therefore, spread of fire and the like of the plurality of secondary batteries 210 is prevented, and a more excellent effect can be obtained.

In addition, as long as the heat absorbing agent 230 is in a gel state, the viscosity of the heat absorbing agent 230 is increased, and thus the heat absorbing agent 230 is less likely to fall off from the secondary battery 210. Therefore, since the secondary battery 210 is more likely to be extinguished by the heat absorbing agent 230, a more excellent effect can be obtained.

In this case, as long as the heat absorbing agent 230 contains sodium polyacrylate as the polymer compound, the secondary battery 210 is efficiently cooled using the heat absorbing agent 230, and thus a remarkably excellent effect can be obtained.

In addition, in a case where the heat conduction sheet 2212 has the opening 2212K and the housing cup 2211 is meltable, as long as the opening 2212K is arranged at a position overlapping the protrusion 2211T, a large amount of the heat absorbing agent 230 is more likely to be released toward the secondary battery 210 at the time of abnormality occurrence. Therefore, the secondary battery 210 is more likely to be efficiently extinguished, and a more excellent effect can be obtained.

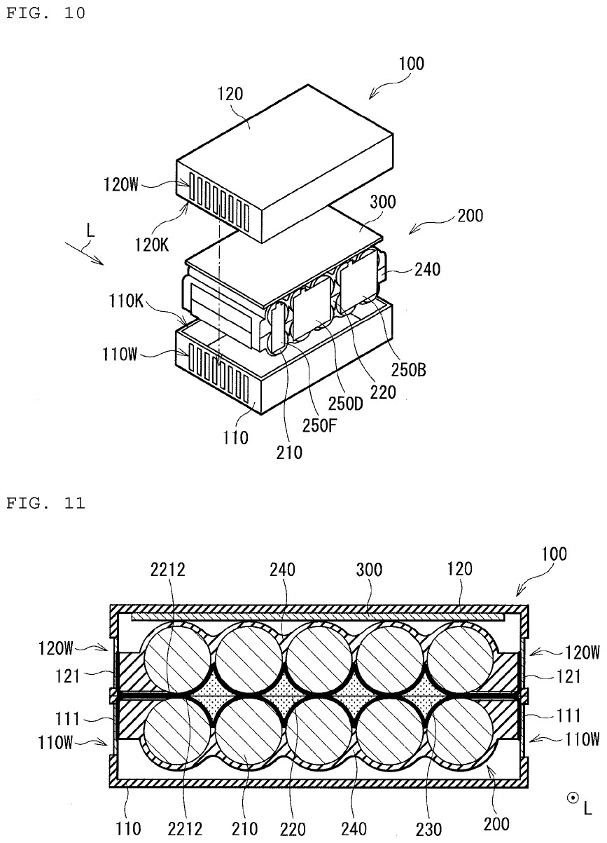

As illustrated in FIG. 10 corresponding to FIG. 1 and FIG. 11 corresponding to FIG. 3, the heat dissipation port 110W having a slit-shaped window may be provided on a side surface of the lower case 110, and the lower case 110 may include the heat dissipation plate 111.

Here, since the lower case 110 has the heat dissipation port 110W arranged on the back side and the heat dissipation port 110W arranged on the front side, the lower case 110 has two heat dissipation ports 110W in total. Since lower case 110 includes the heat dissipation plate 111 arranged on the back side and the heat dissipation plate 111 arranged on the front side, the lower case 110 includes two heat dissipation plates 111 in total. Here, in FIG. 10, the heat dissipation port 110W on the back side is not viewable, and only the heat dissipation port 110W on the front side is viewable.

The heat dissipation port 110W is an opening for releasing heat conducted to lead-out end portion 2212E of the lower partition plate 221 (heat conduction sheet 2212) to the outside of the exterior case 100, and is arranged to overlap the lead-out end portion 2212E. Here, the heat dissipation port 110W may overlap the entire lead-out end portion 2212E or may overlap a part of the lead-out end portion 2212E.

The heat dissipation plate 111 is a thermally conductive shielding member that shields the inside of the battery pack so as not to be viewable from the heat dissipation port 110W, and is attached to the lower case 110 at a position overlapping the heat dissipation port 110W. Here, the heat dissipation plate 111 may overlap the entire heat dissipation port 110W or may overlap a part of the heat dissipation port 110W.

In particular, the heat dissipation plate 111 having thermal conductivity is positioned between the heat dissipation port 110W and the lead-out end portion 2212E, and is coupled to the lead-out end portion 2212E. As a result, the heat dissipation plate 111 has a function of guiding the heat conducted to the lead-out end portion 2212E to the heat dissipation port 110W.

A material for forming heat dissipation plate 111 is not particularly limited as long as it is a material having thermal conductivity. Specifically, the heat dissipation plate 111 is a metal sheet, and specific examples of the metal sheet include an aluminum foil and a copper foil. Alternatively, the heat dissipation plate 111 is a polymer compound having thermal conductivity, and the polymer compound has a thermal conductivity of 0.3 W/m·K or more.

The reason why the lower case 110 includes the heat dissipation port 110W and the heat dissipation plate 111 is that the heat dissipation plate 111 guides heat to the heat dissipation port 110W as described above. In this case, when heat is generated inside the battery pack (secondary battery 210), the heat is more likely to be released from the heat dissipation port 110W to the outside of the battery pack via the lower partition plate 221 (heat conduction sheet 2212) and the heat dissipation plate 111. In addition, since the outside air is introduced into the battery pack through the heat dissipation port 110W, each of the heat dissipation plate 111 and the lead-out end portion 2212E is more likely to be cooled by the outside air.

In this case, the progress of the excessive exothermic reaction of the secondary battery 210 is still suppressed using the heat absorbing agent 230, and the excessive temperature rise of the battery pack is still suppressed using the heat conduction sheet 2212, and thus excellent safety can be obtained.

In particular, the heat conducted to the lead-out end portion 2212E of the lower partition plate 221 (heat conduction sheet 2212) is more likely to be released from the heat dissipation port 110W to the outside of the battery pack via the heat dissipation plate 111, and thus a more excellent effect can be obtained. In this case, as long as the heat dissipation port 110W is arranged at a position overlapping the lead-out end portion 2212E and the lead-out end portion 2212E is coupled to the heat dissipation plate 111, heat is more likely to be sufficiently released to the outside of the battery pack. As a result, heat is less likely to be accumulated inside the battery pack. Therefore, when the heat dissipation plate 111 is used to shield the heat dissipation port 110W, heat is still more likely to be guided from the lead-out end portion 2212E to the heat dissipation port 110W via the heat dissipation plate 111, and therefore heat dissipation can be secured.

Although detailed description is omitted here, the upper case 120 may have a configuration similar to the configuration of the lower case 110 as illustrated in FIGS. 10 and 11. That is, the heat dissipation port 120W may be provided on a side surface of the upper case 120, and the upper case 120 may include the heat dissipation plate 121. The configuration and function of each of the heat dissipation port 120W and the heat dissipation plate 121 are similar to the configuration and function of each of the heat dissipation port 110W and heat dissipation plate 111.

Also in this case, the heat conducted to the lead-out end portion 2212E of the upper partition plate 222 (heat conduction sheet 2212) is more likely to be released from the heat dissipation port 120W to the outside of the battery pack via the heat dissipation plate 121, and thus a more excellent effect can be obtained.

Here, while the lower case 110 includes the heat dissipation port 110W and the heat dissipation plate 111, the upper case 120 may not include the heat dissipation port 120W and the heat dissipation plate 121. Alternatively, while the upper case 120 includes the heat dissipation port 120W and the heat dissipation plate 121, the lower case 110 may not include the heat dissipation port 110W and the heat dissipation plate 111.

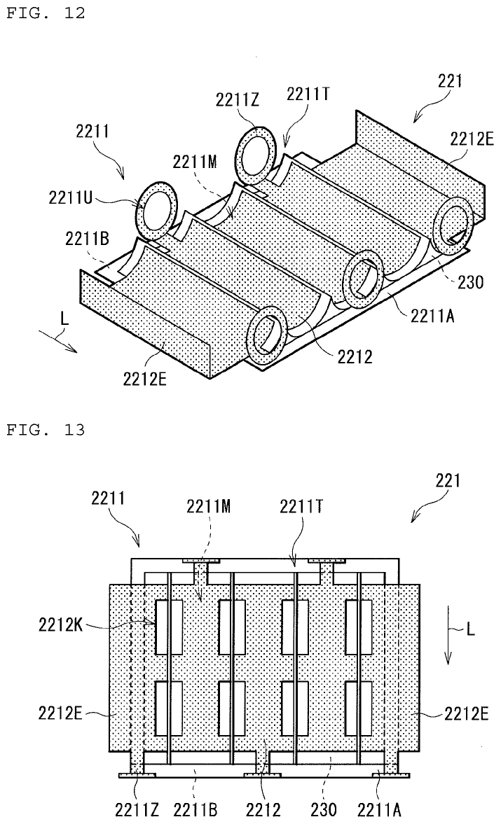

In a case where the heat conduction sheet 2212 has a plurality of openings 2212K, as illustrated in FIG. 12 corresponding to FIG. 5 and FIG. 13 corresponding to FIG. 9, the heat conduction sheet 2212 of the lower partition plate 221 may include a plurality of extension portions 2212Z.

The extension portion 2212Z is a portion where the heat conduction sheet 2212 is extended so as to allow coupling to a part of the lead plates 250A to 250F, and has a ring shape in which the opening 2212U is provided. The opening 2212U is provided in the extension portion 2212Z in order to electrically connect each of the plurality of secondary batteries 210 and a part of each of the lead plates 250A to 250F to each other via the extension portion 2212Z as described later. Here, since the lower partition plate 221 supports the five secondary batteries 210, the heat conduction sheet 2112 includes five extension portions 22122.

The shape of the extension portion 2212Z is not particularly limited as long as it has the opening 2212U, and thus can be arbitrarily set. Here, the shape defined by the outer edge of the extension portion 2212Z is circular, and a circular opening 2212U is provided in the extension portion 2212Z.

Here, in a case where the heat conduction sheet 2212 has conductivity, the heat conduction sheet 2212 is separated from each other between two secondary batteries 210 adjacent to each other, and is isolated from each other. Here, since the lower partition plate 221 supports five secondary batteries, the heat conduction sheet 2212 is separated and isolated from each other at four places.

As described above, in a case where the battery can 211 has a negative polarity because the battery can 211 is electrically connected to the negative electrode lead 214N, each of the five extension portions 2212Z is arranged between each of the five negative electrode terminal portions 210N having the same polarity as the polarity (negative polarity) of the battery can 211 and each of the lead plates 250B to 250F. That is, five extension portions 2212Z are arranged at positions facing the negative electrode terminal portion 210N of five secondary batteries 210.

As a result, each of the lead plates 250B to 250F is coupled to the extension portion 22122, and is electrically connected to each of the five negative electrode terminal portions 210N via the extension portion 2212Z. In this case, the extension portion 2212Z is coupled to the secondary battery 210.

In this case, the progress of the excessive exothermic reaction of the secondary battery 210 is still suppressed using the heat absorbing agent 230, and the excessive temperature rise of the battery pack is still suppressed using the heat conduction sheet 2212, and thus excellent safety can be obtained.

In particular, the heat conducted to heat conduction sheet 2212 of the lower partition plate 221 is guided to the lead plates 250B to 250F via the extension portion 2212Z. Therefore, the heat generated in the secondary battery 210 is further more likely to be dispersed without being accumulated, and thus a more excellent effect can be obtained.

In this case, since the heat conduction sheet 2212 separated and isolated from each other between two secondary batteries 210 adjacent to each other, when the extension portion 22122 is coupled to the battery can 211, occurrence of a short circuit in the plurality of secondary batteries 210 can be prevented.

Although detailed description is omitted here, the upper partition plate 222 may have a configuration similar to the configuration of the lower partition plate 221. That is, the heat conduction sheet 2212 of the upper partition plate 222 may include the extension portion 22122, and the heat conduction sheet 2212 may be separated and isolated from each other.

Also in this case, the heat conducted to the heat conduction sheet 2212 of the upper partition plate 222 is guided to the lead plates 250A to 250F via the extension portion 2212Z. Therefore, while the short circuit of the plurality of secondary batteries 210 is prevented, the heat generated in the secondary batteries 210 is further more likely to be dispersed without being accumulated, and thus a more excellent effect can be obtained.

That is, although not specifically illustrated here, in a case where the battery can 211 has a positive polarity because the battery can 211 is electrically connected to the positive electrode lead 214P, each of the five extension portions 22122 may be arranged between each of the five positive electrode terminal portions 210P having the same polarity as the polarity (positive polarity) of the battery can 211 and each of the lead plates 250A to 250E. That is, five extension portions 2212Z may be arranged at positions facing the positive electrode terminal portion 210P of the five secondary batteries 210. Thus, each of the lead plates 250A to 250E may be coupled to the extension portion 22122, and electrically connected to each of the five positive electrode terminal portions 210P via the extension portion 2212Z.

Also in this case, while the short circuit of the plurality of secondary batteries 210 is prevented, the heat generated in the secondary batteries 210 is more likely to be dispersed without being accumulated, and thus the same effect as in the case where the battery can 211 has a negative polarity can be obtained.

Note that in a case where the heat conduction sheet 2212 does not have conductivity and has insulation, the heat conduction sheet 2212 may not be separated and isolated from each other regardless of the polarity of the battery can 211. This is because the extension portion 2212Z has neither positive polarity nor negative polarity, and thus when a part of the lead plates 250A to 250F is electrically connected to the secondary battery 210 via the extension portion 22122, a short circuit of the plurality of secondary batteries 210 still does not occur.

The application of the battery pack is not particularly limited, as long as the battery pack is applied to machines, devices, instruments, apparatuses, systems, and the like (assembly of a plurality of devices or the like) that can use the battery pack as a driving power supply, a power storage source for reserve of power, and the like.

The battery pack for use as a power supply may be served as a main power supply or an auxiliary power supply. The main power supply is a power supply that is used preferentially, regardless of the presence or absence of other power supplies. The auxiliary power supply may be, for example, a power supply which is used instead of the main power supply, or a power supply which is switched from the main power supply as necessary. When the battery pack is used as an auxiliary power supply, the main power supply is not limited to the battery pack.

Examples of the application of the battery pack are as follows. The battery pack can be applied to electronic devices (including portable electronic devices) such as video cameras, digital still cameras, mobile phones, notebook personal computers, cordless phones, headphone stereos, portable radios, portable TVs, and portable information terminals. The battery pack can be applied to portable household appliances such as electric shavers. The battery pack can be applied to storage devices such as backup power supplies and memory cards. The battery pack can be applied to power tools such as electric drills and electric saws. The battery pack can be applied to medical electronic devices such as pacemakers and hearing aids. The battery pack can be applied to electric vehicles such as electric cars (including hybrid cars). The battery pack can be applied to power storage systems such as domestic battery systems that store electric power in preparation for emergency or the like. Of course, the application of the battery pack may be an application other than the above.

Although the present technology has been described with reference to one or more embodiments, the present technology is not limited to the aspect described herein, and various modifications can be made with respect to the present technology.

For example, the case where the battery structure of the secondary battery is cylindrical has been described, for example; however, the battery structure of the secondary battery applied to the battery pack of the present technology is not particularly limited. Specifically, the battery structure of the secondary battery may be a laminate film type, a square type, a coin type, or the like.

In addition, the case where the secondary battery has the wound structure has been described, but the structure of the secondary battery is not particularly limited. Specifically, the secondary battery may have another structure such as a laminated structure.

Further, lithium has been used as an electrode reactant of the secondary battery, but the kind of the electrode reactant is not particularly limited. Specifically, the electrode reactant may be another element of Group 1 in the long-periodic table such as sodium or potassium, an element of Group 2 in the long-periodic table such as magnesium or calcium or another light metal such as aluminum.

Note that the effects described in the present description are merely examples and are not limited, and other effects may be provided.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a plurality of batteries;
an isolating member that is arranged among the plurality of batteries and isolates the plurality of batteries from each other; and
a heat absorbing agent that is housed in the isolating member and cools the plurality of batteries,
wherein
the isolating member includes:
a housing portion that is arranged among the plurality of batteries and houses the heat absorbing agent inside; and
a heat conduction part that is arranged between the housing portion and each of the plurality of batteries, the heat conduction part having a thermal conductivity higher than a thermal conductivity of the housing portion.

2. The battery pack according to claim 1, wherein the heat conduction part includes a lead-out end portion led out to an outside of the housing portion.

3. The battery pack according to claim 1, wherein the heat absorbing agent contains water.

4. The battery pack according to claim 3, wherein
the heat absorbing agent further contains a polymer compound, and
the heat absorbing agent has a gel state in which the water is retained by the polymer compound.

5. The battery pack according to claim 4, wherein the polymer compound contains sodium polyacrylate.

6. The battery pack according to claim 1, wherein the heat conduction part is divided into a plurality of parts that are isolated from each other.

7. The battery pack according to claim 1, wherein the heat conduction part has one or two or more openings.

8. The battery pack according to claim 1 further comprising a plurality of connection members that is coupled to each of the plurality of batteries and electrically connects the plurality of batteries to each other,
wherein
the heat conduction part includes a plurality of extension portions having a ring shape,
each of the plurality of batteries includes a first exterior member that accommodates a battery element inside, and includes a terminal portion having a polarity that is positive or negative,
the first exterior member has a polarity that is positive or negative,
the heat conduction part is separated between two of the batteries adjacent to each other and is isolated from each other,
the extension portions are arranged between the terminal portion having a same polarity as a polarity of the first exterior member and the connection members, and
the connection members are coupled to the extension portions, and are electrically connected to the terminal portion having the same polarity as the polarity of the first exterior member via the extension portions.

9. The battery pack according to claim 1, wherein the housing portion is meltable at a temperature in a range of 120° ° C. to 270° C. inclusive.

10. The battery pack according to claim 9, wherein
the housing portion includes a protrusion that is positioned among the plurality of batteries and isolates the plurality of batteries from each other,
the heat conduction part has one or two or more openings,
a part of the heat absorbing agent is housed in the protrusion, and
the one or two or more openings are arranged at positions overlapping the protrusion.

11. The battery pack according to claim 1 further comprising a holding member that is arranged around the plurality of batteries and holds the plurality of batteries isolated from each other by the isolating member,
wherein
the heat conduction part includes a lead-out end portion led out to an outside of the housing portion, and
the lead-out end portion is exposed to an outside of the holding member.

12. The battery pack according to claim 11 further comprising a second exterior member that accommodates the plurality of batteries, the isolating member, and the heat absorbing agent inside,
wherein the lead-out end portion is coupled to the second exterior member.

13. The battery pack according to claim 1 further comprising a second exterior member that accommodates the plurality of batteries, the isolating member, and the heat absorbing agent, and has a heat dissipation port.

14. The battery pack according to claim 13, wherein
the heat conduction part includes a lead-out end portion led out to an outside of the housing portion, and
the heat dissipation port is arranged at a position overlapping the lead-out end portion.

15. The battery pack according to claim 13, wherein
the heat conduction part includes a lead-out end portion led out to an outside of the housing portion,
the second exterior member includes a shielding member that is thermally conductive and shields the heat dissipation port, and
the lead-out end portion is coupled to the shielding member.

16. The battery pack according to claim 1, wherein each of the plurality of batteries is a secondary battery.
